(19) United States
(12) Patent Application Publication
(10) Pub. No.: US 2012/0268088 A1
(43) Pub. Date: Oct. 25, 2012

(54) DC TO DC BUCK CONVERTING CONTROLLER

(75) Inventors: Li-Min Lee, New Taipei City (TW); Chung-Che Yu, New Taipei City (TW); Shian-Sung Shiu, New Taipei City (TW); Chao Shao, Wuxi (CN)

(73) Assignee: GREEN SOLUTION TECHNOLOGY CO., LTD., New Taipei City (TW)

(21) Appl. No.: 13/284,974

(22) Filed: Oct. 30, 2011

(30) Foreign Application Priority Data
Apr. 21, 2011 (CN) 201110100828.0

(51) Int. Cl. G05F 1/46

(52) U.S. Cl. 323/271

(57) ABSTRACT

A constant on-time period of a DC to DC buck converting controller is adjusted according to a level of a preset output voltage. Therefore, the DC to DC buck converting controller of the present invention is suitable for any applications with different requests of output voltages or different operating mode.

### CROSS-REFERENCE TO RELATED APPLICATION

This application claims the priority benefit of China application serial no. 201110100828.0, filed on Apr. 21, 2011. The entirety of the above-mentioned patent application is hereby incorporated by reference herein and made a part of this specification.

### BACKGROUND OF THE INVENTION

1. Field of the Invention

The present invention relates to a DC to DC buck converting controller, and more particularly a DC to DC buck converting controller with programmable output voltage.

2. Description of Related Art

FIG. 1 is a schematic diagram of a conventional DC to DC buck converting circuit. The DC to DC buck converting circuit comprises a controller 10, two switches M1 and M2, an inductance L, a capacitance C, a bootstrap circuit BS and a voltage divider VD. The voltage divider VD detects an output voltage of the buck converting circuit and accordingly generates a feedback signal FB. The controller 10 turns the switches M1 and M2 on/off according to the feedback signal FB, so as to make the DC to DC buck converting circuit to convert an input signal Vin into an output voltage Vout which is stabilized at a preset output voltage.

The controller 10 comprises a comparator 12, a constant on-time period circuit 14, a logic control circuit 16 and two gate driving units 18, 20. The comparator 12 generates a feedback control signal according to the feedback signal FB and a reference voltage Vref. An on-time period of the constant on-time period circuit 14 is determined by the input voltage Vin and the output voltage Vout, and the constant on-time period circuit 14 generates an constant on-time signal according to the feedback control signal. The logic control circuit 16 determines conduction timing and cut-off timing of the switches M1 and M2, and makes the switches M1 and M2 turned on and off separately via the gate driving units 18 and 20. The switch M2 is a N-type MOSFET. For avoiding that the gate driving unit 20 in the controller 10 cannot generate a signal which is high enough to turn on the switch M2. The bootstrap circuit BS is used supply a sufficiently high voltage to the gate driving unit 20.

The constant on-time period circuit 14 adjusts the constant on-time period according to the input voltage Vin and the output voltage Vout to make the DC to DC buck converting circuit operate in a quasi-constant frequency. Therefore, an electromagnetic interference (EMI) generated by the switches M1 and M2 can be easily filtered out, regardless of the levels of the input voltage Vin and the output voltage Vout.

However, the DC to DC buck converting circuit must economize on energy to meet the current energy-saving trend, which means that the DC to DC buck converting circuit needs energy-saving mode to adjust output voltage. Therefore, it is an important issue to support the energy-saving mode on the DC to DC buck converting circuit.

### SUMMARY OF THE INVENTION

The invention uses an extra setting signal to set the level of the output voltage to achieve the function of energy-saving mode for adjusting the output voltage.

To accomplish the aforementioned and other objects, an exemplary embodiment of the invention provides a DC to DC buck converting controller, adapted to control a DC to DC buck converting circuit which converts an input voltage into an output voltage. The DC to DC buck converting controller comprises a feedback circuit and a driving circuit. The feedback circuit generates a feedback control signal according to a reference voltage and a feedback signal representative of the output voltage. The driving circuit generates at least one control signal to control the DC to DC buck converting circuit according to the feedback control signal. The driving circuit comprises a constant on-time period unit. The constant on-time period unit sets a constant on-time period to make the driving circuit to determine a duty cycle of the DC to DC buck converting circuit according to the level of the reference voltage. Wherein, the level of the reference voltage is determined by a preset output voltage.

It needs to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The present invention will now be specified with reference to its preferred embodiment illustrated in the drawings, in which:

FIG. 1 is a schematic diagram of a conventional DC to DC buck converting circuit;

FIG. 2 is a schematic diagram of a DC to DC buck converting circuit according to a first embodiment of the invention; and

FIG. 3 is a schematic diagram of a constant on-time period circuit according to an example shown in the FIG. 2.

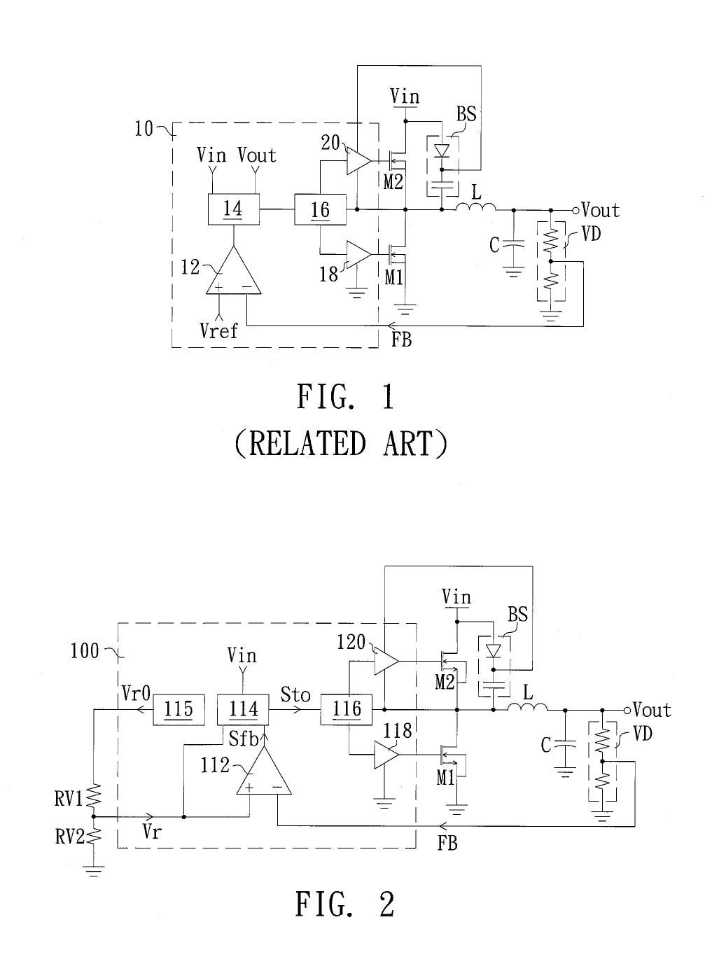

### DESCRIPTION OF EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

FIG. 2 is a schematic diagram of a DC to DC buck converting circuit according to a first embodiment of the invention. The DC to DC buck converting circuit comprises a controller 100, two switches M1 and M2, an inductance L, a capacitance C, a bootstrap circuit BS and a voltage divider VD. The voltage divider VD detects an output voltage Vout of the DC to DC buck converting circuit and accordingly generates a feedback signal FB. The controller 100 turns the switches M1 and M2 on/off according to the feedback signal FB, so as to make the DC to DC buck converting circuit convert an input voltage Vin into an output voltage Vout which is stabilized at a preset output voltage.

The controller 100 comprises a feedback circuit 112, a driving circuit which comprises a constant on-time period circuit 114, a logic control circuit 116 and two gate driving units 118, 120. The feedback circuit 112 comprises a comparator. An inverting input terminal of the comparator receives the feedback signal FB and a non-inverting input terminal thereof receives a reference voltage Vr and accordingly outputs a feedback control signal Sfb. The constant on-time period circuit 114 receives the feedback control signal Sfb and the reference voltage Vr and accordingly generates a constant on-time signal Sto. A pulse width (time period) of the constant on-time signal Sto is determined by a level of the reference voltage Vr. A starting timing of the constant on-time signal Sto, i.e., rising/falling edge, is determined according to the feedback control signal Sfb. The logic control circuit 116 is coupled with a connection node of the two switches M1 and M2 to detect a current of the inductance L and determine turned-on timings and turned-off timings of the two switches M1 and M2 according to the feedback control signal Sfb and the current of the inductance L. The logic control circuit 116 turns the two switches M1 and M2 on/off via the gate driving units 118 and 120 respectively. In the present embodiment, a duty cycle of the DC to DC buck converting circuit, i.e., a time ratio of a period time to transmit the power from the input voltage Vin into the DC to DC buck converting circuit via the switch M1 and a cycle time thereof, is determined by turned-on period of the switch M1. That is, when a beginning of each cycle (when the level of the feedback signal FB is lower than the level of the reference voltage Vr), the feedback circuit 112 generates a feedback control signal Sfb to make the constant on-time period circuit 114 to generate the constant on-time signal Sto with a constant pulse width (time period). The logic control circuit 116 turns on the switch M1 according to the constant on-time signal Sto. After the constant pulse width (time period), the logic control circuit 116 turns the switch M1 off and turns the switch M2 on to make the current of the inductance L freewheel through the switch M2. When the current of the inductance L is decreased to zero, the switch M2 is turned off.

The reference voltage Vr may be an external control signal, which a level of the reference voltage Vr is determined by an external circuit or set by users according to a preset output voltage. In the present embodiment, the controller 100 further comprises a reference voltage generating circuit 115. The reference voltage generating circuit 115 generates a reference base voltage Vr0. The user makes the reference base voltage Vr0 divided into a demand reference voltage Vr by a voltage divider and transmits the reference voltage Vr into the feedback circuit 112 and the constant on-time period circuit 114. The voltage divider comprises the resistances RV1, RV2 and a voltage division ratio thereof is set by the input voltage Vin and the preset output voltage. In addition, the voltage division ratio of the voltage divider VD may affect the ratio of the feedback signal FB and the output voltage Vout. Therefore, the ratio of the resistances RV1, RV2 is set according to the voltage division ratio of the voltage divider VD.

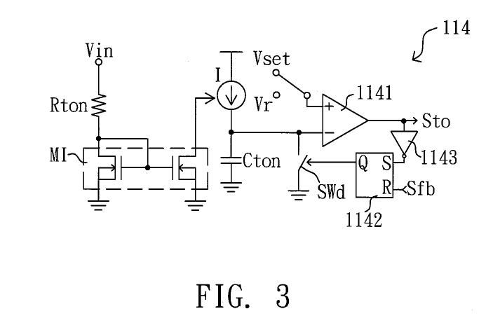

FIG. 3 is a schematic diagram of a constant on-time period circuit according to a second embodiment of the invention. The constant on-time period circuit 114 comprises a current source I, a period capacitance Cton and a comparator 1141. The current of the current source I is set by a current mirror MI and an on-time period resistance Rton. The on-time period resistance Rton is coupled with the input voltage

Vin and so a current flowing through the on-time period resistance depends on the the input voltage Vin. The current flowing through the on-time period resistance is mirrored to the current source I by the current mirror MI. On the beginning of each cycle, the period capacitance Cton is charging from zero by the current source I. The comparator 1141 compares the voltage of the period capacitance Cton with one of the original voltage Vset and the reference voltage Vr to generate the constant on-time signal Sto, and the original voltage Vset is higher than the reference voltage Vr. On the beginning of enabling the circuit, the comparator 1141 compares the voltage of the period capacitance Cton with the original voltage Vset to make the on-time period longer and so the output voltage Vout could be increased faster. Just before or when the output voltage Vout reaches the preset voltage, the comparator 1141 compares the voltage of the period capacitance Cton with the reference voltage Vr to make the output voltage Vout to be stabilized on the preset output voltage. The constant on-time period circuit 114 further comprises a SR flip-flop 1142 and an inverter 1143. A set terminal S of the SR flip-flop 1142 is coupled with the output terminal of the comparator 1141 through the inverter 1143, a reset terminal R thereof is coupled with the feedback circuit 112 and an output terminal is coupled with the discharging unit SWd. The discharging unit SWd is coupled with two ends of the period capacitance Cton to discharge the period capacitance Cton according to the controlling of the SR flip-flop 1142. When the voltage of the period capacitance Cton is higher than the reference voltage Vr, the constant on-time signal Sto is changed into low level to trigger the SR flip-flop 1142 through the inverter 1143. Then, the discharging unit SWd discharges the period capacitance Cton. When the output voltage Vout is lower than the preset voltage, the feedback control signal Sfb is at high level to make the SR flip-flop 1142 reset to stop the discharging unit SWD discharging. Therefore, on the beginning of each cycle, the output voltage Vout is lower than the preset output voltage and the period capacitance Cton is charged by the current sources I. When the voltage of period capacitance C is higher than the reference voltage Vr, the period capacitance Cton is discharged to zero voltage to wait for the next cycle.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A DC to DC buck controller, adapted to control a DC to DC buck converting circuit which converts an input voltage into an output voltage, the buck converting comprising:
a feedback circuit, generating a feedback control signal according to a reference voltage and a feedback signal representative of the output voltage; and
a driving circuit, generating at least one control signal to control the DC to DC buck converting circuit according to the feedback control signal, and the driving circuit comprising a constant on-time period unit which sets a constant on-time period according to the level of the reference voltage and determining a duty cycle of the DC to DC buck converting circuit;
wherein the level of the reference voltage is determined by a preset output voltage.

2. The DC to DC buck converting controller according to claim 1, further comprising a reference voltage generating circuit which generates a reference base voltage, wherein the reference voltage is generated according to the reference base voltage by a voltage divider which has a voltage division ratio determined according to the input voltage and the preset output voltage.

3. The DC to DC buck converting controller according to claim 2, wherein the feedback circuit comprises a comparator which generates a feedback control signal according to the reference voltage and the feedback signal.

4. The DC to DC buck converting controller according to claim 2, wherein the constant on-time period unit comprises a current source, a period capacitance and a comparator and the current source supplies a charging current to charge the period capacitance, and the current value of the charging current is set according to the input voltage and the comparator sets the constant on-time period according to a voltage of the period capacitance and the reference voltage.

5. The DC to DC buck converting controller according to claim 4, wherein the constant on-time period unit further comprises a discharging unit which determines a discharging timing of the period capacitance according to a comparison result of the comparator and the feedback control signal.
